(19) United States
(12) Patent Application Publication
(10) Pub. No.: US 2012/0000742 A1
(43) Pub. Date: Jan. 5, 2012

(54) LAMINATED ARMATURE FOR TORQUE MODULATION OF SPRING-ENGAGED BRAKE OR CLUTCH

(75) Inventor: Thomas Curran Sekella, Elmira, NY (US)

(73) Assignee: SEPAC, INC., Elmira, NY (US)

(21) Appl. No.: 12/829,468

(22) Filed: Jul. 2, 2010

(51) Int. Cl. F16D 67/06

(52) U.S. Cl. 192/18 B

(57) ABSTRACT

An electromagnetically actuated, spring loaded brake or clutch for infinitely modulating control of braking torque includes a shaft rotatable about its long axis, a rotor including a friction disk mounted on the shaft in a rotationally stable manner, a magnetic body, which can be energized to produce a magnetic force, a spring-loaded laminated armature plate assembly, with the armature plate mounted on the shaft and movable axially parallel to the long axis of the shaft by the magnetic force produced in the magnetic body against the force of its spring-loading, such that the laminations flex progressively, causing the armature assembly to effectively walk across the air gap, rather than suddenly jumping from one position to another and thus providing a soft stop, when the brake is applied, and the torque vs. power function can be modulated either by varying the number of laminations, their individual thicknesses, and/or their materials.

### BACKGROUND OF THE INVENTION

1. Field of the Invention

The invention pertains to the field of spring-engaged clutches and brakes. More particularly, the invention pertains to a laminated armature plate for a spring-engaged clutch or brake, which allows for infinitely modulating control of brake/clutch torque.

2. Description of Related Art

Spring-engaged clutches and brakes are used in a variety of applications for which it is desirable that the clutch or brake be engaged or coupled, when there is an absence of electrical power. This frequently is referred to as a “fail-safe” design. For example, a “fail-safe” clutch often is used in cooling fan applications, where it is desirable to turn the fan “ON” and “OFF” to control the temperature of a device, but in the event of a loss of control, it would be safer for the fan to be “ON” continuously and over-cool. Spring-engaged “fail-safe” brakes are more common in their application to moving devices (e.g., elevators, fork trucks, wind turbines, etc.), which are safer stopped than moving.

U.S. Pat. No. 5,154,261 discloses an electromagnetic disc brake for an elevator lifting apparatus, which includes a disc spline-coupled with a rotational shaft, a braking body and an armature disposed to clamp the disc. Braking springs press the armature against the disc, and an iron core is provided, which includes inner and outer magnetic poles each facing the armature and concentrically formed with respect to the rotational shaft. An electromagnetic coil generates magnetic flux to pass through the inner and outer magnetic poles as magnetic paths, with at least one of the pole face of the outer magnetic pole and the facing portion of the armature where it faces this pole face being provided with means for increasing a magnetic gap. The braking springs are disposed in portions of the outer magnetic pole.

U.S. Pat. No. 5,497,860 discloses an electromagnetic brake apparatus of the type which includes (a) an electromagnet mounted on a magnet support and having a magnet face, and (b) an armature block mounted for movement with respect to the electromagnet. The magnet face is generally coincident with a reference plane when the magnet is deenergized. The magnet support is of the cantilever type and is able to bend slightly. When the electromagnet is energized, the magnet face and armature block can therefore become parallel to one another, even though the armature block is at a position (usually because of mis-adjustment) at which such parallelism would not be possible, but for the bending magnet support. When such support bends, the magnet face is at an angle to a first reference plane with which such face is coincident, when the support is not bent. The armature block is also at an angle to such reference plane. Misalignment between the electromagnet and the block is reduced at the instant of electromagnet energization and through the time the block comes into full surface contact with the face of the electromagnet.

U.S. Pat. No. 6,321,883 discloses an electromagnetically actuated brake comprising a magnetic body, which can be energized electromagnetically to produce a magnetic force, and a brake rotor which is mounted on a shaft, in particular the drive shaft of an electric motor, in a rotationally stable manner, so that the shaft can be braked. A spring-loaded armature plate is mounted on the shaft and is movable axially parallel to the long axis of the shaft by the magnetic force produced in the magnetic body against the force of its spring loading, whereby in a braked state the armature plate is apposed to the braking surface of the brake rotor. Disposed between the armature plate and the magnetic body or between the armature plate and the brake rotor are first and second dampers to attenuate oscillations of the brake. The first and second damper are located adjacent one another in the axial direction of the shaft and each comprises a material different from that of the other.

One limitation of current spring-engaged brake (SEB) designs is that the level of braking torque is either zero, when the electrical power is applied, or 100%, when the power is removed. Due to its primary function as a “fail-safe” device, the 100% torque level is selected in order to handle the most demanding set of conditions. However, the sudden application of this torque level can induce a shock load into the machinery in the rotating system. This can cause damage or unbalance in high inertia systems, such as wind turbines, for example.

One known variation of a spring-engaged brake (SEB) is described in U.S. Pat. No. 5,057,728, which discloses a three-step electric brake that includes a two-coil/two-armature configuration, and which offers the potential of three torque levels in steps. However, because of the hysteresis that is inherent in this (or any typical SEB) design, torque cannot be modulated to a degree finer than the three bi-stable levels.

However, the inventor has discovered that by modifying the armature plate design as herein described, it is possible to have a single-coil SEB configuration that functions as a “fail-safe” brake and have infinitely modulating control of braking torque over the full range. To Applicant's knowledge, the prior art fails to teach or describe such an armature plate design, which offers infinitely modulating control of braking torque over the full range.

### SUMMARY OF THE INVENTION

The present invention provides a laminated armature plate for a spring-engaged clutch or brake, which allows for infinite torque modulation of the clutch or braking torque over the full range.

An electromagnetically actuated, spring engaged brake or clutch for infinitely modulating control of braking torque includes a shaft rotatable about its long axis, a rotor including a friction disk mounted on the shaft in a rotationally stable manner, a magnetic body, which can be energized to produce a magnetic force, a spring-loaded laminated armature plate assembly, with the armature plate mounted on the magnet body and movable axially parallel to the long axis of the shaft by the magnetic force produced in the magnetic body against the force of its spring-loading, such that the laminations flex progressively, causing the armature assembly to effectively walk across the air gap, rather than suddenly jumping from one position to another and thus providing a soft stop, when the brake is applied, and the torque vs. power function can be modulated either by varying the number of laminations, their individual thicknesses, and/or their materials.

The preferred embodiment includes a laminated armature plate assembly comprising a thick ferromagnetic low carbon, low alloy steel lamination adjacent to said friction disc, one or more thinner ferromagnetic steel laminations located between said first thick lamination and said magnetic body, one or more very thin non-magnetic spacer laminations separating said ferromagnetic steel laminations, and wherein said non-magnetic spacer laminations comprise one or more copper alloys, as described in further detail below.

The present invention further provides method for infinitely modulating control of braking torque of an electromagnetically actuated, spring loaded brake or clutch, allowing soft stop braking to be achieved by programming a reduction of electrical power to produce a desired torque vs. time function. This is particularly useful in certain applications, such as, for example, in wind turbines, where a soft stop is highly desirable. Furthermore, the torque vs. power function can be modulated either by varying the number of laminations, their individual thicknesses, and/or their materials, as described in further detail below.

These and other objects, features and advantages will become readily apparent from the following Detailed Description, which should be read in conjunction with the accompanying drawing figures.

### BRIEF DESCRIPTION OF THE DRAWING

Reference is now made to the accompanying drawings. The drawings are not necessarily to scale, with the emphasis instead placed upon the principles of the present invention. Additionally, each of the embodiments depicted herein are but one of a number of possible arrangements, utilizing the fundamental concepts of the present invention. The drawings are briefly described as follows.

FIG. 1 shows a cross-sectional view a spring-engaged brake with the power off.

FIG. 2 shows a cross-sectional view the spring-engaged brake of FIG. 1 with the power on.

FIG. 3 shows a graph of torque as a function of electrical power for a spring-engaged clutch or brake, illustrating hysteresis inherent in a bi-stable armature design.

FIG. 4 shows a cross-sectional view a modulating spring-engaged brake of the present invention with the power off.

FIG. 5 shows a cross-sectional view a modulating spring-engaged brake of the present invention with the power on 100%.

FIG. 6 shows a cross-sectional view a modulating spring-engaged brake of the present invention with the power on 25-30%

FIG. 7 shows a cross-sectional view a modulating spring-engaged brake of the present invention with the power on 50-60%

FIG. 8 shows a graph of torque as a function of electrical power for a modulating armature spring-engaged clutch or brake of the present invention.

### DETAILED DESCRIPTION

The following description relates to certain preferred embodiments of apparatus made in accordance with the present invention. It will be readily apparent that numerous variations and modifications other than those specifically indicated will be readily apparent to those of sufficient skill in the field. In addition, certain terms are used throughout the discussion in order to provide a convenient frame of reference with regard to the accompanying drawings, such as “top” “bottom”, “interior”, “distal”, and the like.

These terms are not intended to be specifically limiting of the invention, except where so indicated in the claims.

The present invention provides a method for infinitely modulating control of braking torque of an electromagnetically actuated, spring loaded brake or clutch, allowing soft stop braking to be achieved by programming a reduction of electrical power to produce a desired torque vs. time function. This is particularly useful in certain applications, such as, for example, in wind turbines, where a soft stop is highly desirable. Furthermore, the torque vs. power function can be modulated either by varying the number of laminations, their individual thicknesses, and/or their materials.

In accordance with a preferred embodiment of the invention, a laminated armature plate assembly comprises a thick ferromagnetic low carbon, low alloy steel lamination adjacent to said friction disc, one or more thinner ferromagnetic steel laminations located between said first thick lamination and said magnetic body, one or more very thin non-magnetic spacer laminations separating said ferromagnetic steel laminations, and wherein said non-magnetic spacer laminations comprise one or more copper alloys.

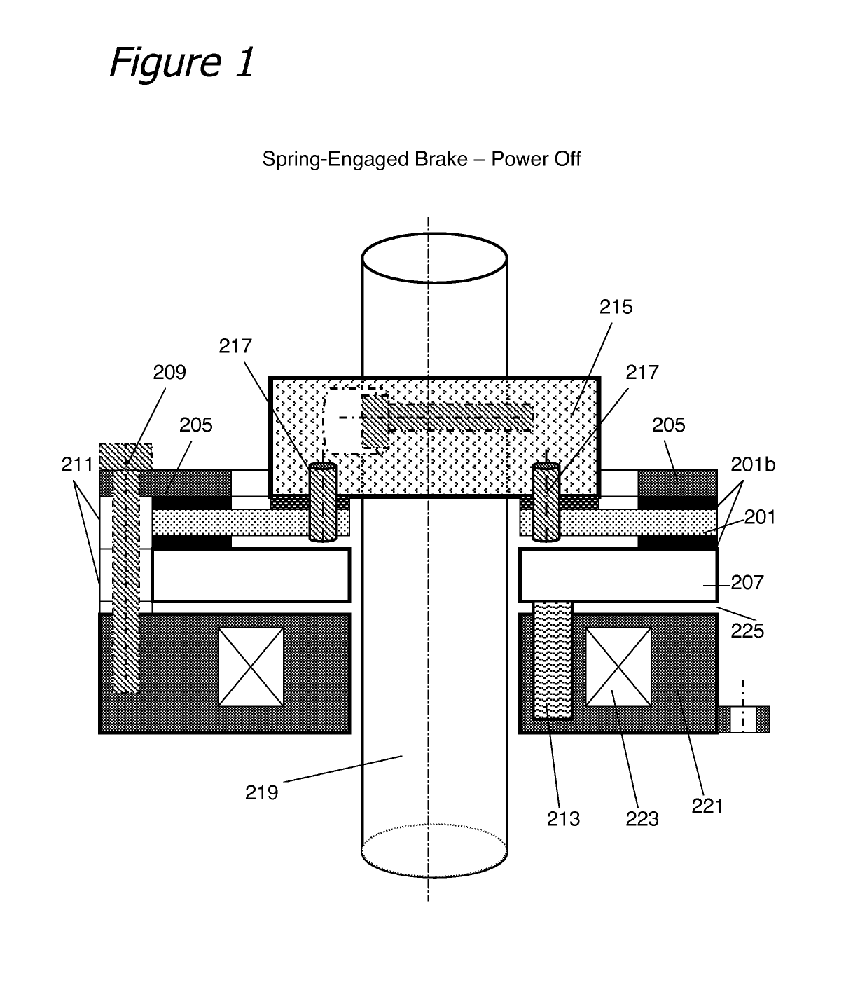

Referring now to FIG. 1, the principal elements of a spring-engaged brake are shown, along with the position of the parts, when no external power is being applied. The friction disc 201, which typically has friction material 201b bonded to both sides of a metal core 201a, is sandwiched between the back plate 205 and the armature plate 207. The back plate 205 is held in position by fasteners 209 and spacers 211 and the armature 207 is forced against the friction disc 201 by compression springs 213. Since the friction disc 201 is free to move axially, it in turn is forced against the back plate 205. The friction disc 201 is coupled to the drive hub 215 through drive pins (as shown) 217, a spline, a hex, or other suitable means allowing free axial motion, but capable of transmitting torque. The drive hub 215 is connected to the shaft 219, and the magnet body 221 is rigidly secured to some convenient stationary part of the machine.

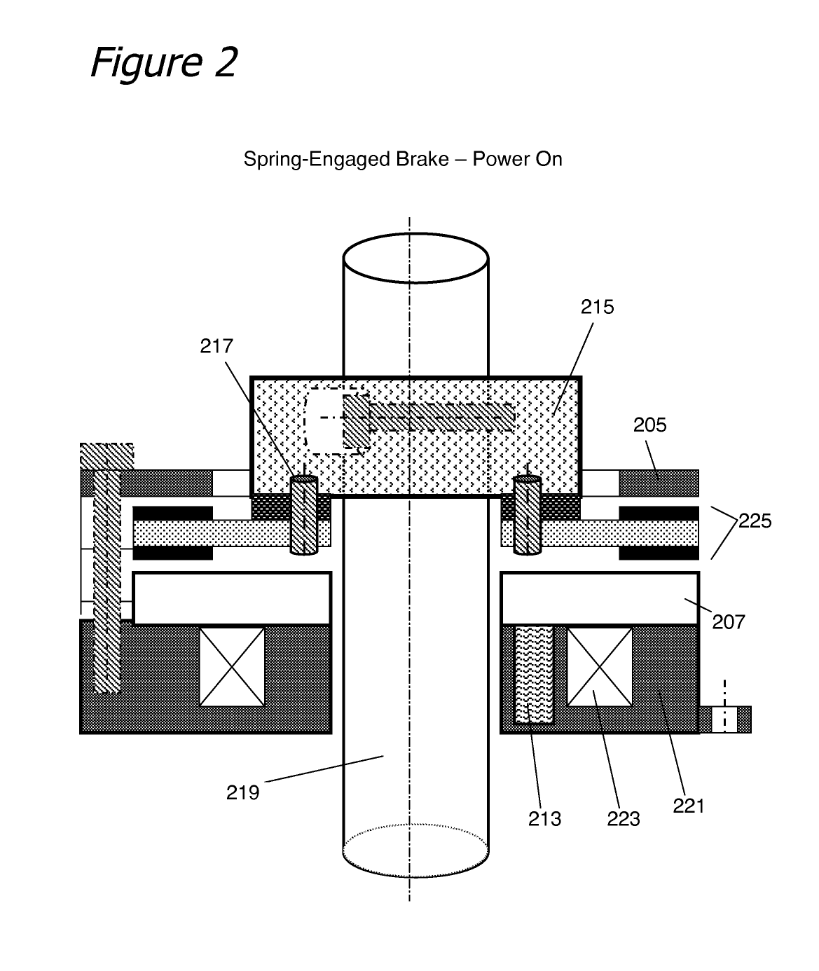

Referring now to FIG. 1, when power is applied to the electromagnetic coil 223, a magnetic field is created through the poles facing the armature 207, generating forces, which tend to attract the armature to the magnet body 221. If the total magnetic force exceeds the total spring force, the armature 207 will move across the air gap 225 (FIG. 1), relieving the clamping forces on the friction disc 201, and producing clearances on either side of the disc (see FIG. 2). To re-engage the brake, power is reduced until the total magnetic force is less than the total spring force.

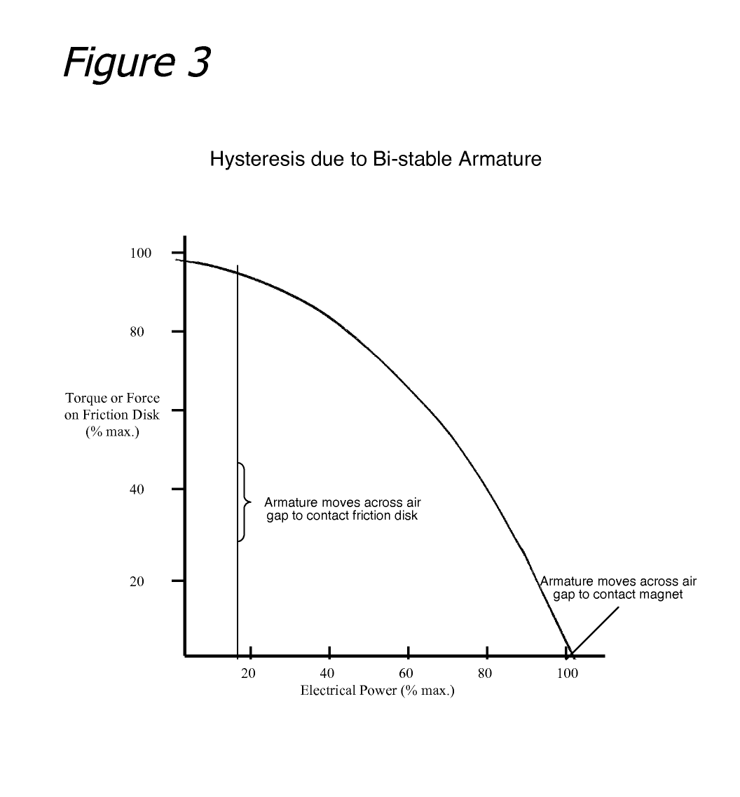

The electrical power required to produce a particular magnetic force is approximately in direct proportion to the size of the air gap. For example, when it is desired to disengage the brake, the air gap may be 0.020″, and it will require 25 watts to produce 100 lb of magnetic force. It will require only 3 watts to produce the same force, when the brake is disengaged and we want to re-engage it. This is because the air gap has been reduced to 0.001-0.002″. This creates a hysteresis, which is quite large and prohibitive, when we want to use the brake for modulating torque in the lower region of its capability. FIG. 3 shows a graph of torque as a function of electrical power, and its hysteresis, for a typical spring engaged clutch or brake.

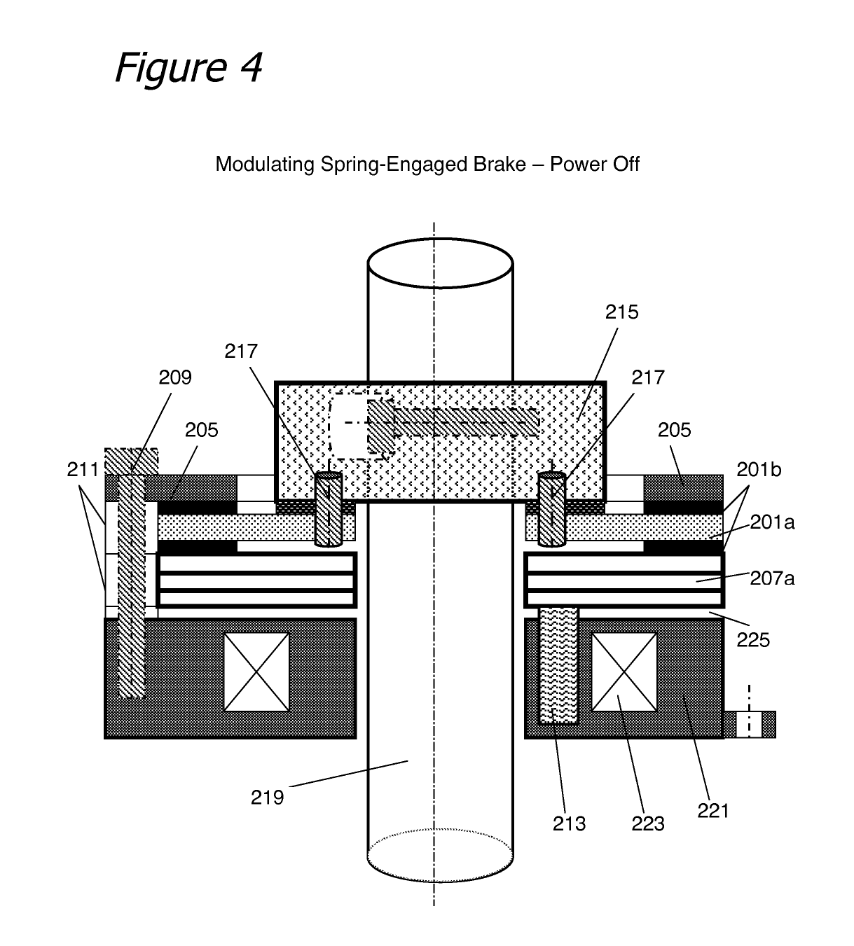

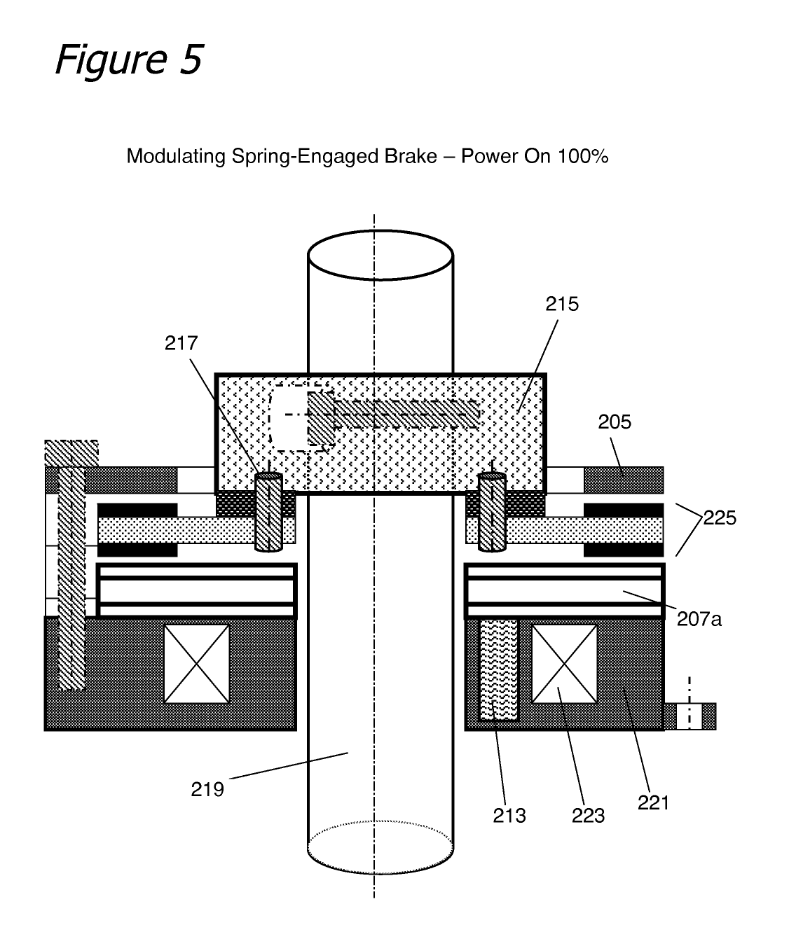

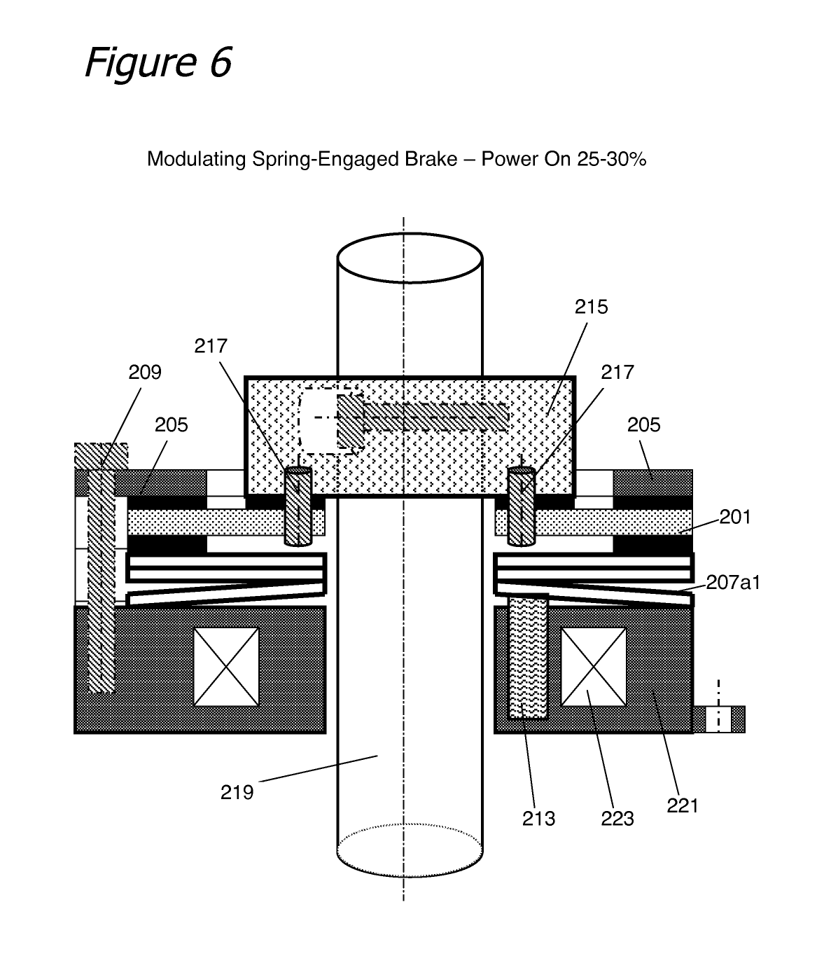

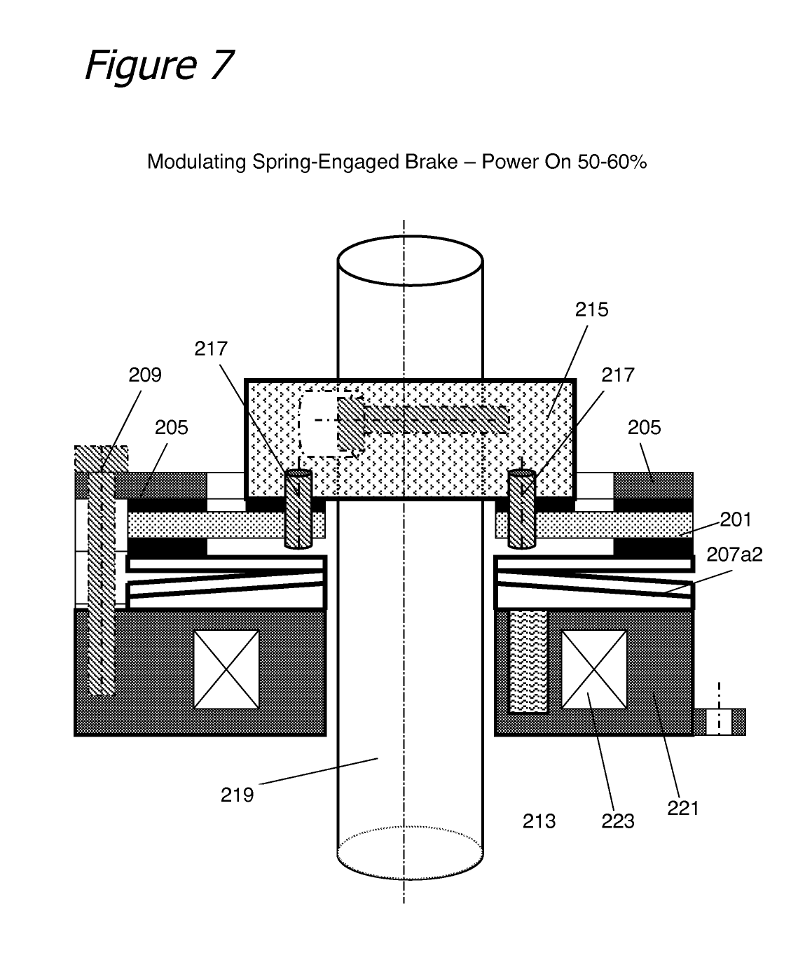

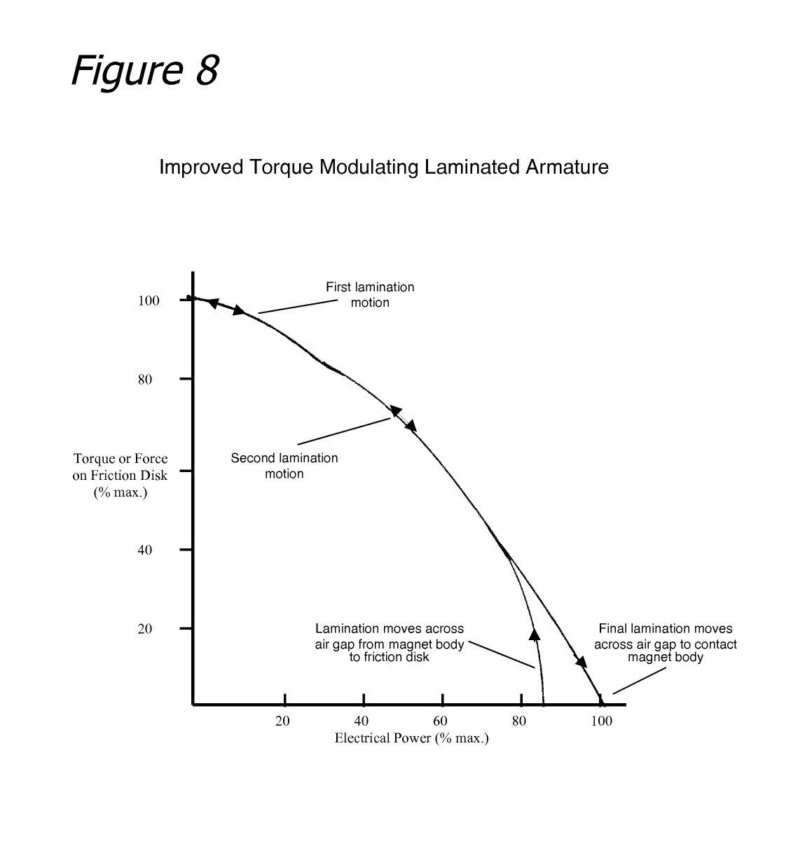

The inventor has found that by changing the armature plate from a single thickness to having multiple laminations, the clutch or brake can be made to function like the original design in terms of “fail-safe” operation, but in addition the hysteresis is substantially reduced. FIG. 4 and FIG. 5 show this design with the power off and power fully on, respectively. The difference is evident in FIG. 6 and FIG. 7. These show the laminations flexing progressively, causing the armature assembly to effectively “walk” across the air gap, rather than suddenly jumping from one position to another. The armature lamination closest to the friction disc must be of sufficient thickness to remain flat, since this is essential for proper frictional braking function performance. In addition, the springs should be located at either the inner pole (as shown) or the outer pole. If springs are used at both poles, there must be a difference in force, because flexing of the thin laminations would be inhibited, if the spring force is equal at both poles. FIG. 8 shows the typical hysteresis curve for this design.

The actual torque-vs.-power function can be tailored to some extent by varying the number of laminations, their individual thicknesses, and their material (magnetic or non-magnetic). One configuration tested consists of thick and thin steel laminations interlayered with very thin non-magnetic laminations between them.

The laminated armature of the present invention preferably comprises: 1) a thick ferromagnetic steel lamination adjacent to the friction disc; 2) at least one, and preferably 2 or 3, thinner ferromagnetic steel laminations, optionally of different thicknesses, located between the first thick lamination and the electromagnet; and 3) very thin non-magnetic spacer laminations separating the steel laminations.

The thick lamination preferably is made from low carbon, low alloy steel for its good ferromagnetic properties and low cost. The thinner laminations preferably are made from stronger steel, due to the flexing of them as part of the transition process from the clutch or brake being engaged to disengaged. The non-magnetic spacer laminations optionally are made from copper alloys, such as, for example, brass, stainless steel (300 series), or a layer of suitable composition tape that has been applied to armatures in similar applications, and can be applied to the laminations. All of these parts can be machined from steel bars, but the preferred and least expensive method would be to stamp them from sheet steel.

For the wind turbine market, a “soft stop” is desired. This can be achieved by programming the reduction of electrical power to result in the desired torque vs. time function.

The above-described method of making and using the laminated armature plate of the present invention provides a cost effective and efficient manner of providing infinite torque modulation of a clutch or braking torque over the full range of braking power. While preferred embodiments and methods have been described in detail, various modifications, alterations, and changes may be made without departing from the spirit and scope of the present invention as defined in the appended claims. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An electromagnetically actuated, spring loaded brake or clutch comprising:
a shaft rotatable about its long axis;
a hub mounted on said shaft in a rotationally stable manner and connected to a friction disk by which said shaft can be braked;
a magnetic body comprising a brake magnet body or clutch rotor, which can be energized electromagnetically to produce a magnetic force;
a spring-loaded armature plate mounted on said brake magnet body or clutch rotor and movable axially parallel to said long axis of said shaft by said magnetic force produced in said magnetic body against the force of its spring-loading; and
at least one compression spring to generate said spring-loading of said armature plate, whereby, when said magnetic body is de-energized, said armature plate is pressed against said friction disc by said spring-loading, thereby applying a braking force to said shaft;
wherein said armature plate comprises means for infinitely modulating control of braking torque.

2. The apparatus of claim 1, wherein said means for infinitely modulating control of braking torque comprises a laminated armature plate assembly.

3. The apparatus of claim 2, comprising a plurality of compression springs for generating said spring-loading of said armature plate.

4. The apparatus of claim 2, wherein said laminated armature plate assembly comprises a plurality of laminations reversibly separable through a portion of said laminated armature plate.

5. The apparatus of claim 4, wherein one or more of said armature plate laminations flex progressively, in response to the amount of magnetic force produced in said magnetic body.

6. The apparatus of claim 5, wherein said armature plate lamination closest to said friction disc is of sufficient thickness to remain flat, regardless of the amount of magnetic force produced in said magnetic body.

7. The apparatus of claim 3, wherein at least one of said compression springs is located at either an inner pole or an outer pole of said magnetic body.

8. The apparatus of claim 3, wherein said compression springs are located at both poles of said magnetic body and wherein each spring generates a difference in force from the other.

9. The apparatus of claim 2, wherein torque vs. power function is modulated either by varying the number of laminations, their individual thicknesses, and/or their materials.

10. The apparatus of claim 2, wherein said laminated armature plate assembly comprises thick and thin steel laminations interlayered with very thin non-magnetic laminations therebetween.

11. The apparatus of claim 2, wherein said laminated armature plate assembly comprises:
a) a thick ferromagnetic steel lamination adjacent to said friction disc;
b) one or more thinner ferromagnetic steel laminations located between said first thick lamination and said magnetic body; and
c) one or more very thin non-magnetic spacer laminations separating said ferromagnetic steel laminations.

12. The apparatus of claim 11, wherein said laminated armature plate assembly comprises a plurality of ferromagnetic steel laminations of different thicknesses.

13. The apparatus of claim 11, wherein said thick lamination comprises a low carbon, low alloy steel.

14. The apparatus of claim 11, wherein said non-magnetic spacer laminations comprise one or more copper alloys.

15. The apparatus of claim 11, wherein said non-magnetic spacer laminations are selected from the group consisting of brass, 300 series stainless steel, or a layer of composition tape applied to said laminations

16. The apparatus of claim 4, wherein soft stop braking is achieved by programming a reduction of electrical power to produce a desired torque vs. time function.

17. The apparatus of claim 6, wherein said laminated armature plate assembly comprises:
a) a thick ferromagnetic low carbon, low alloy steel lamination adjacent to said friction disc;
b) one or more thinner ferromagnetic steel laminations located between said first thick lamination and said magnetic body;
c) one or more very thin non-magnetic spacer laminations separating said ferromagnetic steel laminations; and
d) wherein said non-magnetic spacer laminations comprise one or more copper alloys.

18. The apparatus of claim 17, wherein torque vs. power function is modulated either by varying the number of laminations, their individual thicknesses, and/or their materials, and soft stop braking is achieved by programming a reduction of electrical power to produce a desired torque vs. time function.

19. A method for infinitely modulating control of braking torque of an electromagnetically actuated, spring loaded brake or clutch, comprising the steps of:
a) providing an electromagnetically actuated, spring loaded brake or clutch in accordance with claim 5; and
b) providing soft stop braking by programming a reduction of electrical power to produce a desired torque vs. time function.

20. The method of claim 19, wherein torque vs. power function is modulated either by varying the number of laminations, their individual thicknesses, and/or their materials.
